(19) United States
(12) Patent Application Publication
(10) Pub. No.: US 2019/0262947 A1
(43) Pub. Date: Aug. 29, 2019

(54) Fabrication of Fluorescence-Raman Dual Enhanced Modal Biometal Substrate

(71) Applicant: BEIHANG UNIVERSITY, Beijing (CN)

(72) Inventors: Yingchun Guan, Beijing (CN); Jiaru Zhang, Beijing (CN); Libin Lu, Beijing (CN); Huaming Wang, Beijing (CN)

(73) Assignee: BEIHANG UNIVERSITY

(21) Appl. No.: 16/261,573

(22) Filed: Jan. 30, 2019

(30) Foreign Application Priority Data
Feb. 26, 2018 (CN) 201810161983.5

(51) Int. Cl. B23K 26/352; G01N 21/65; B23K 26/60

(52) U.S. Cl. CPC B23K 26/352; B23K 26/60; G01N 21/658

(57) ABSTRACT

The present invention disclosed a method for fabrication of fluorescence-Raman dual enhanced modal biometal substrate. The method comprises the steps of grinding surface of the substrate with different types of sandpapers to remove an oxide layer and smooth the surface of the substrate; wherein a roughness of the surface is less than 0.1 μm; cleaning the grinded substrate in an ultrasonic bath to remove any impurity; placing the specimen on the stage of an ultrashort laser system; processing the specimen at a certain laser processing parameters by a galvanometer; finally, three-dimensional micro-nano structure is fabricated on the specimen. The technique of the present invention is promising for large-scale commercial application because it is simple and economical, while the enhanced Raman and fluorescence signal is stable and high reproducibility.

### CROSS REFERENCE OF RELATED APPLICATION

This application claims priority under 35 U. S. C. 119(a-d) to CN 201810161983.5, filed Feb. 26, 2018.

### BACKGROUND OF THE PRESENT INVENTION

### Field of Invention

The present invention is generally related to a method for fabrication of fluorescence-Raman dual enhanced modal biometal substrate, particularly to laser manufacturing and biosensing fields.

### Description of Related Arts

Fluorescence spectroscopy is a well-developed technique with wide availability of instrumentation, chemical tools, and analytical protocols, especially for fluorescence-based applications in biology due to the fast readout and high sensitivity. However, fluorophore molecules may encounter photobleaching or quenching during the process of sample preparation. Moreover, the autofluorescence of biological samples could interfere with the specific fluorescent signal. These limitations may complicate and hinder fluorescence detecting.

Raman spectroscopy provides more reliable results for quantitative analysis due to the high resistance to photobleaching. In addition, it could reach ultrasensitivity down to single molecule level. This technique has been used to identify intermediate species such as active oxygen species, hydroxyl groups and surface oxides. But normal Raman spectroscopy is not sensitive enough to monitor trace amounts of surface species on metal catalysts. Surface-enhanced Raman scattering (SERS) profiting from the efficient excitation of surface plasmon resonances (SPRs) has been employed to circumvent this limitation. Meanwhile, an increment of the fluorescence signal can be also observed through plasmonic interactions, which is known as metal-enhanced fluorescence (MEF). Building on the continuous advances in nanofabrication techniques, SERS are progressively emerging as an extremely powerful tool for the ultrasensitive and quantitative applications across many fields of science, especially for biomedical applications. However, as compared to fluorescence, SERS remains a low-throughput imaging technique that requires long acquisition time.

Thus, the integration of SERS and fluorescent signals into the same substrate is a natural consequence. In this dual-mode sensing approach, the fluorescence read-out is typically monitored in the first step for fast screening, while SERS measurements are selectively carried out at the specific areas of interest identified by fluorescence tracking to achieve a high level of multiplex-target discrimination, analytical resolution, and quantification. The state-of-the-art available techniques of fluorescence-Raman dual enhanced modal biometal substrate are organized films and colloidal system. Although they have high sensitivity, the high cost, strict experimental condition, sophisticated preparation and low stability limited its practical applications.

To solve the problems, the present invention provides a method for fabrication of fluorescence-Raman dual enhanced modal biometal substrate by one-step using an ultrafast laser. The laser induces large areas of three-dimensional periodic micro-nano structure without using precious metals such as gold or silver coatings. The local electromagnetic field induces a large area of surface plasmon resonance, which leads to the dramatic enhancement of the Raman and fluorescent signals from molecules located in close proximity to the metallic surface. The metal substrate is vital with high detection capability. The substrate is easy to produce and economic, which is able to be produced on a commercial scale.

### SUMMARY OF THE PRESENT INVENTION

The main object of the present invention is to provide a method for fabrication of fluorescence-Raman dual enhanced modal biometal substrate. The present invention solves the problems of the conventional metal nanoparticles colloids, such as low repeatability, non-coherent and so on. The present invention does not require any precious metal coating such as gold or silver. A large area of three-dimensional periodic micro-nano structures is produced by ultrafast laser. The micro-nano structures comprise micro periodic wave structure, sub-micro periodic stripe structure and nano metal particles. The local surface plasmon resonance (LSPR) and surface plasmon polaritons (SPP) can be induced by sub-micro periodic stripe structure and nano metal particles, respectively. The combined effect of LSPR and SPP can avoid fluorescence quenching and enhance the signal of fluorescence and Raman. The micro periodic wave structure improves the capability of the spectral detection from the arbitrary angel. Hence, the substrate with three-dimensional periodic micro-nano structures can be used for fluorescence imaging and SERS analysis. The method of preparing the substrate is simple, economical and stable, which is suitable for large-scale industrial production.

The present invention provides the method for fabrication fluorescence-Raman dual enhanced modal biometal substrate. The method comprises the following steps:

step 1: grinding the substrate with different types of sandpapers to remove oxide layer and smooth the surface of the specimen; wherein the roughness of the surface of the substrate is less than 0.1 μm; cleaning the ground specimen in an ultrasonic bath to remove impurity;

step 2: placing the specimen on the stage of the ultrashort pulse laser system; processing the specimen at certain laser processing parameters by a galvanometer; finally, a three-dimensional micro-nano structure is fabricated on the substrate;

wherein the different types of sandpapers in step 1 for grinding specimen is in a sequence of 360 mesh, 600 mesh, 800 mesh, 1000 mesh, 2000 mesh and 4000 mesh; the time for an ultrasonic bath is the 20 s;

wherein the laser parameters in step 2 are laser power of 0.5-50 W, laser wavelength of 325-1064 nm, laser pulse width of 10-900 fs, PRF (pulse repetition frequency) of 50-900 KHz, scan rate of 100-3000 mm/s and scanning time of 1-200 times;

the substrate is biometal such as copper, titanium, aluminum and so on;

the ultrashort pulse laser in step 2 is femtosecond laser;

wherein the three-dimensional micro-nano structure in step 2 consists microstructure and nanostructure the nanostructure in step 2 is fabricated on the microstructure;

the microstructure in step 2 is periodical wave or sawtooth structure; the nanostructure is linear, pillar, mesh or particle structure;

wherein the period of microstructure in the step 2 ranges from 10 to 500 μm; the period of nanostructure ranges from 20 to 900 nm; the diameter of a nanoparticle ranges from 1 to 100 nm; the height of the microstructure in the step 2 ranges from 5 to 20 μm

The structure of fluorescence-Raman dual enhanced modal biometal substrate in the present invention is a three-dimensional periodic micro-nano structure which consists of microstructure and nanostructure.

The present invention invents a new method for fabrication of fluorescence-Raman dual enhanced modal biometal substrate which has the following advantages:

1: The three-dimensional micro-nano structure enables the substrate have the precondition for both the fluorescence imaging and SERS analysis

2: The substrate is able to avoid interference between the SERS signal and fluorescence signal to achieve satisfying fluorescence and SERS signal of the analyte;

3: Different size of three-dimensional periodic micro-nano structure is able to be prepared for different analytes;

4: The fluorescence is excited and detected from the arbitrary angel due to the complex morphology induced scattering;

5: The signals are detected with high sensitivity;

6: The substrate with good biocompatibility can be widely used in biomedical fields;

7: The substrate is easy to produce and does not require precious metal coatings.

### BRIEF DESCRIPTION OF THE DRAWINGS

FIG. 1 is a flowchart of preparing fluorescence-Raman dual enhanced modal biometal substrate by ultrafast laser;

FIG. 2 is SEM (Scanning Electron Microscope) images of three-dimensional micro-nano structures formed by adopting a preparing method in embodiment 1;

FIG. 3 is confocal microscopy images of the three-dimensional micro-nano structures formed by adopting the preparing method in embodiment 1;

FIG. 4 is enhanced fluorescence spectroscopy of crystal violet by adopting fluorescence-Raman dual enhanced modal biometal substrate in the embodiment 1;

FIG. 5 is the enhanced Raman spectroscopy of crystal violet by adopting the fluorescence-Raman dual enhanced modal biometal substrate in the embodiment 1.

### DETAILED DESCRIPTION OF THE PREFERRED EMBODIMENT

In order to better illustrate the present invention, further explanation is given below with a reference to the drawings.

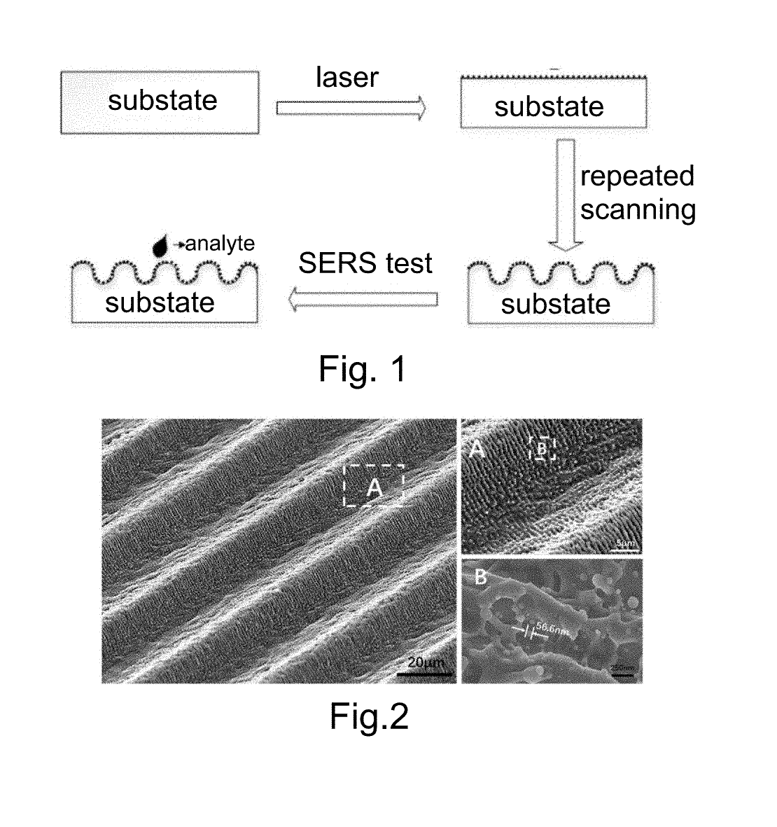

As illustrated in the FIG. 1, the present invention provides a method for fabrication of fluorescence-Raman dual enhanced modal biometal substrate, which comprises the following steps:

step 1: grinding the substrate with different types of sandpapers to remove oxide layer and smooth the surface of the specimen; wherein the roughness of the surface of the substrate is less than 0.1 μm; cleaning the ground specimen in an ultrasonic bath to remove impurity;

step 2: placing the specimen on the stage of the ultrashort pulse laser system; processing the specimen at a certain laser processing parameters by a galvanometer; finally, a three-dimensional micro-nano structure is fabricated on the substrate;

step 3: clean the processed specimen briefly;

wherein the different types of sandpapers in step 1 for grinding specimen is in a sequence of 360 mesh, 600 mesh, 800 mesh, 1000 mesh, 2000 mesh and 4000 mesh; the time for an ultrasonic bath is 20 s;

the laser parameters in step 2 are a laser power of 0.5-50 W, a laser wavelength of 325-1064 nm, a laser pulse width of 10-900 fs, a PRF of 50-900 KHz, a scan rate of 100-3000 mm/s and a scanning time of 1-200 times;

### Embodiment 1

(1) Preparing a TC4 specimen with an area of 10*10 mm and thickness of 2 mm; cleaning the substrate in the 100% alcohol; grinding the surface of the specimen in a sequence of 360 mesh, 600 mesh, 800 mesh, 1000 mesh, 2000 mesh and 4000 mesh sandpaper in turn; cleaning the grinded specimen within ultrasonic bath for 20 s;

(2) Placing the cleaned TC4 specimen on the stage of an ultrashort pulse laser system (the wavelength is 1030 nm; the beam diameter is 35 μm; the pulse width is 800 fs); wherein the laser parameters are set as the following: power 2 W; frequency: 300 KHz; scan rate: 1500 mm/s; scanning time: 15 times; scanning area: 800*800 μm; the scanning route is one-direction parallel line; starting the laser processing system;

(3) When the process is completed, the three-dimensional periodic micro-nano structure for SERS and fluorescence substrate is achieved.

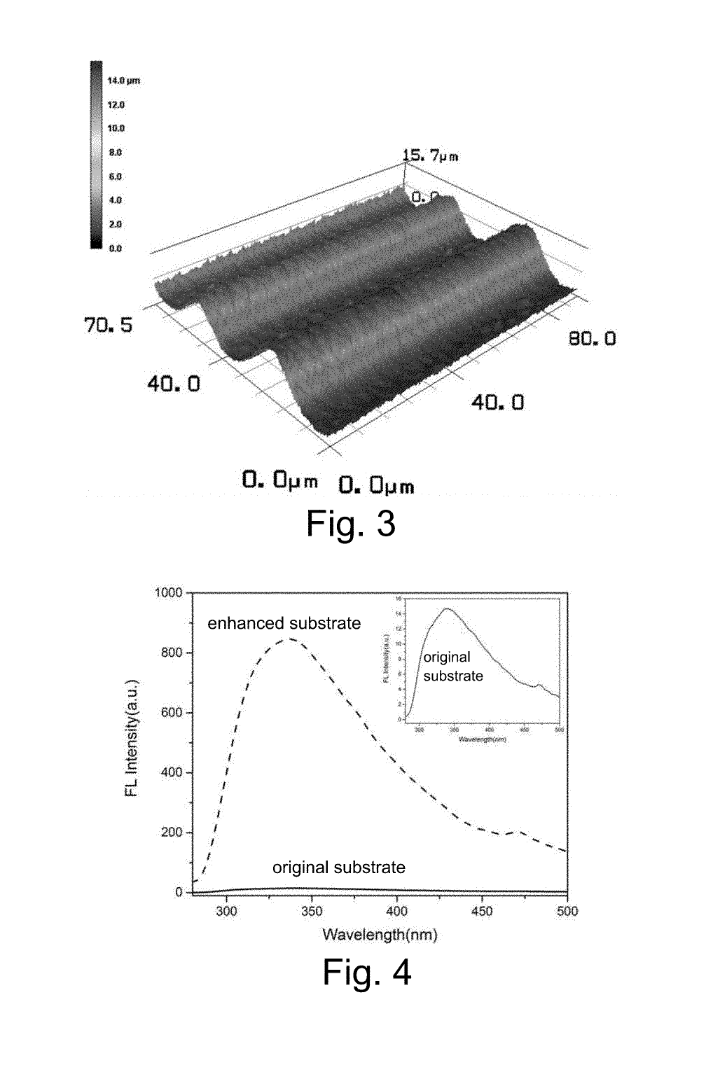

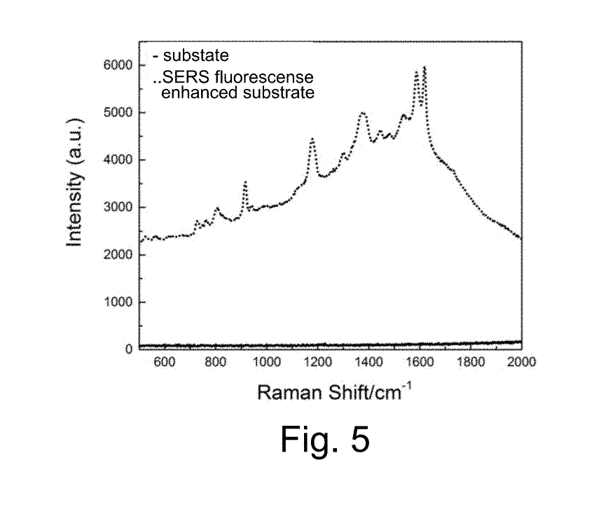

FIG. 2 is the SEM image of three-dimensional micro-nano structures formed by adopting a preparing method in embodiment 1; FIG. 3 is the confocal microscopy image of the three-dimensional micro-nano periodic structures formed by adopting the preparing method embodiment 1; FIG. 4 is the enhanced crystal violet fluorescence spectroscopy by adopting fluorescence-Raman dual enhanced modal biometal substrate in embodiment 1; FIG. 5 is the enhanced Raman signal of crystal violet by adopting the fluorescence-Raman dual enhanced modal biometal substrate in the embodiment 1.

### Embodiment 2

(1) Preparing a copper specimen with an area of 10*10 mm and thickness of 2 mm; cleaning the substrate in the 100% alcohol; grinding the surface of the specimen in a sequence of 360 mesh, 600 mesh, 800 mesh, 1000 mesh, 2000 mesh and 4000 mesh sandpaper in turn; cleaning the grinded specimen within ultrasonic bath for 20 s;

(2) Placing the cleaned copper specimen on the stage of an ultrashort pulse laser system (the wavelength is 800 nm; the beam diameter is 35 μm; the pulse width is 600 fs); wherein the laser parameters are set as the following: power 1 W; frequency: 200 KHz; scan rate: 1500 mm/s; scanning time: 20 times; scanning area: 800*800 μm; the scanning route is one-direction parallel line; starting the laser processing system;

(3) When the process is completed, the three-dimensional periodic micro-nano structure for SERS and fluorescence substrate is achieved.

### Embodiment 3

(1) Preparing an aluminum specimen with an area of 10*10 mm and thickness of 2 mm; cleaning the substrate in the 100% alcohol; griding the surface of the specimen in a sequence of 360 mesh, 600 mesh, 800 mesh, 1000 mesh, 2000 mesh and 4000 mesh sandpaper in turn; cleaning the grinded specimen within ultrasonic bath for 20 s;

(2) Placing the cleaned aluminum specimen on the stage of an ultrashort pulse laser system (the wavelength is 532 nm; the beam diameter is 35 μm; the pulse width is 600 fs); wherein the laser parameters are set as the following: power 0.5 W; frequency: 600 KHz; scan rate: 2500 mm/s; scanning time: 20 times; scanning area: 800*800 μm; the scanning route is one-direction parallel line; starting the laser processing system;

(3) When the process is completed, the three-dimensional periodic micro-nano structure for SERS and fluorescence substrate is achieved.

The techniques disclosed in the application is not a limitation of the invention. Any combinations of the disclosed techniques are within the protection range. The required protection range is described in the claim.

What is claimed is:

1. A method for fabrication of fluorescence-Raman dual enhanced modal biometal substrate, comprising steps of:
Step 1: grinding the substrate with different types of sandpapers to remove an oxide layer and smooth a surface of a specimen; wherein a roughness of the surface of the specimen is less than 0.1 μm; cleaning the ground specimen in an ultrasonic bath to remove impurities; and
Step 2: placing the specimen on a stage of an ultrashort pulse laser system; processing the specimen at certain laser processing parameters by a galvanometer; finally, a three-dimensional micro-nano structure is fabricated on the substrate.

2. The method of preparing fluorescence-Raman dual enhanced modal biometal substrate, as recited in claim 1, wherein the different types of sandpapers grind the substrate in a sequence of 360 mesh, 600 mesh, 800 mesh, 1000 mesh, 2000 mesh and 4000 mesh; the time for the ultrasonic bath is the 20 s.

3. The method of preparing fluorescence-Raman dual enhanced modal biometal substrate, as recited in claim 1, wherein laser parameters are a power 0.5-50 W, a wavelengths 325-1064 nm, a pulse width 10-900 fs, a PRF (pulse repetition frequency) 50-900 KHz, a scan rate 100-3000 mm/s and a scanning frequency 1-200 times.

4. The method of preparing fluorescence-Raman dual enhanced modal biometal substrate, as recited in claim 1, wherein a substrate metal consists of copper, titanium, aluminum and so on.

5. The method of preparing fluorescence-Raman dual enhanced modal biometal substrate, as recited in claim 1, wherein the ultrashort pulse laser in step 2 is a femtosecond laser.

6. The method of preparing fluorescence-Raman dual enhanced modal biometal substrate, as recited in claim 1, wherein the three-dimensional micro-nano structure consists of microstructures and nanostructures.

7. The method of preparing fluorescence-Raman dual enhanced modal biometal substrate, as recited in claim 1, wherein the nanostructure is fabricated on the microstructure; the three-dimensional micro-nano structure is thus formed.

8. The method of preparing fluorescence-Raman dual enhanced modal biometal substrate, as recited in claim 6, wherein the nanostructure is fabricated on the microstructure; the three-dimensional micro-nano structure is thus formed.

9. The method of preparing fluorescence-Raman dual enhanced modal biometal substrate, as recited in claim 1 wherein the microstructure is a periodical structure comprising of a waveform or a sawtooth form; the nanostructure is in a linear, a pillar, a mesh or a particle form.

10. The method of preparing fluorescence-Raman dual enhanced modal biometal substrate, as recited in claim 6, wherein the microstructure is a periodical structure comprising of a waveform or a sawtooth form; the nanostructure is in a linear, a pillar, a mesh or a particle form

11. The method of preparing fluorescence-Raman dual enhanced modal biometal substrate, as recited in claim 1, wherein the period of microstructure ranges from 10 to 500 μm; the period of nanostructure ranges from 20 to 900 μm; the diameter of a nanoparticle ranges from 1 to 100 nm.

12. The method of preparing fluorescence-Raman dual enhanced modal biometal substrate, as recited in claim 6, wherein the period of microstructure ranges from 10 to 500 μm; the period of nanostructure ranges from 20 to 900 μm; the diameter of a nanoparticle ranges from 1 to 100 nm

13. The method of preparing fluorescence-Raman dual enhanced modal biometal substrate, as recited in claim 1, wherein the height of the microstructure ranges from 5 to 20 μm.

14. The method of preparing fluorescence-Raman dual enhanced modal biometal substrate, as recited in claim 6 wherein the height of the microstructure ranges from 5 to 20 μm.
